(19) United States
(12) Patent Application Publication
(10) Pub. No.: US 2013/0339372 A1
(43) Pub. Date: Dec. 19, 2013

(54) SYSTEM AND METHOD FOR CONTEXUAL RANKING OF INFORMATION FACETS

(71) Applicant: Santhosh Adayikkoth, Bangalore (IN)

(72) Inventor: Santhosh Adayikkoth, Bangalore (IN)

(21) Appl. No.: 13/918,096

(22) Filed: Jun. 14, 2013

(30) Foreign Application Priority Data
Jun. 14, 2012 (IN) 2379/CHE/2012

(51) Int. Cl. G06F 17/30

(52) U.S. Cl. CPC G06F 17/30943
USPC 707/748

(57) ABSTRACT

The present disclosure relates to a system and method for dynamic and contextual ranking of information facets of multi-dimensional data. In one embodiment, one or more information facets or dimensions are ranked based on the context of the user and state of the information being observed. The context of observer defines how the user attention will be distributed across multiple facets of information based on the intent, goal and responsibility. The state of the observer is represented by a User Attention vector that is computed offline for multiple users based on the profile of the users and stored in a directory. The state of the information being observed is defined by value or level of significance of various facets of information and is represented by Perspective of value vector (POV) that is computed independent of the users.

This application claims the benefit of Indian Patent Application Filing No. 2379/CHE/2012, filed Jun. 14, 2012, which is hereby incorporated by reference in its entirety.

### FIELD OF THE DISCLOSURE

The present disclosure primarily relates to information retrieval and visualization systems. More particularly, the present disclosure relates to dynamic ranking of information facets based on the context of the user (Observer) as well as that of the information (Observed).

### BACKGROUND

Current day information retrieval and visualization systems need to be capable of accessing and handling enormous volumes of information. One key challenge faced by such systems, handling huge volumes of information, is in the identification of information that may be of interest to users so that the relevant information may be presented to them without overwhelming them with huge volumes of irrelevant information. In enterprise/industrial environments this can get even more complex due to the fragmentation and distribution of enterprise/industrial information and complex interdependencies that exist between the data elements, that it is challenging for stake holders to monitor the industrial ecosystem from various perspectives and understand the true state of the system.

Conventional approaches to identifying information of interest to monitor the industrial ecosystem are not effective in handling end-to-end enterprise data (transactional and master data) that is, fragmented, distributed and has complex interdependencies. They fail in the effective ranking and prioritization of this voluminous data and end up presenting all potentially related information to the users. However when the presented information sets are large, the stakeholders find it difficult to locate the information that is critical and relevant from industrial perspective. Moreover, the conventional approaches make it difficult for the users to locate relevant results from large multi-dimensional, multi-disciplinary, multi-enterprise information.

Therefore, there is a need to provide an improved method and system for enabling the handling of large volumes of relevant information by identifying and prioritizing the ‘facets of observations’ that are truly relevant to an enterprise/industrial situation, regardless of its type and location. In other words, information infrastructure should have the capability to rank and prioritize the key aspects or facets of information based on the context and thus overcoming the disadvantages of the existing art.

### SUMMARY

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of dynamic and contextual ranking of information facets of multi-dimensional data. The method includes receiving information from one or more data source systems and generating a data model for the received information, the data model comprising one or more of at least data entities, attributes and dimensions of the data entities, and associations between the data entities derived from the received information. Further, the method includes, determining a significance value of the data entity based on the one or more attribute information of the data entity in consideration and any triggering events received on that data entity and identifying one or more downstream and upstream entities associated to the data entity in consideration and related to significance value and association of the data entity with the identified downstream and upstream entities. The method further includes computing the significance value of the one or more of the identified downstream and upstream data entities and identifying one or more dimensions of the identified downstream and upstream entities. The method furthermore includes determining a weighted aggregation of the identified one or more dimensions of the identified downstream and upstream entities and ranking the one or more dimensions of the entities based on the aggregate thus determined.

Further, the present disclosure relates to a system for enabling dynamic contextual ranking of multi-dimensional data. The system comprises a user application interface configured to receive information from one or more data source systems and a facet ranker coupled with the user application interface and configured to compute ranking of dimensions of the data entity. The facet ranker comprises at least a backend data computation module configured to determine Perspective of Value (PoV) vector offline based on the context of data in consideration. The facet ranker further comprises an online data computation module coupled with the backend data computation module and configured to compute POV vector based on the navigation state of the user and a ranking module configured to rank the dimensions of the data entity based on the computed POV and User Attention (UA) vectors.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The features of the present disclosure are set forth with particularity in the appended claims. The disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates an exemplary architecture of a contextual facet ranking system in accordance with an embodiment of the present disclosure.

FIGS. 2A and 2B illustrate an exemplary embodiment of offline and online data computation modules respectively in accordance with an embodiment of the present disclosure.

FIG. 3 illustrates an exemplary graph representing graph traversals in accordance with an embodiment of the present disclosure.

FIGS. 4 & 5 illustrate flowchart of method of Backend data computation in accordance with an embodiment of the present disclosure.

FIG. 6 illustrates a flowchart of method of contextual ranking of information facets in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Accordingly, the present disclosure relates to a method of dynamic and contextual ranking of information facets of multi-dimensional data. The method includes receiving information from one or more data source systems and generating a data model for the received information, the data model comprising one or more of at least data entities, attributes and dimensions of the data entities, and associations between the data entities derived from the received information corpora. Further, the method includes, determining a significance value of the data entity based on the one or more attribute information of the data entity in consideration and any trigger events received on that data entity, and identifying one or more downstream and upstream entities associated to the data entity in consideration and related to significance value and association of the data entity with the identified downstream and upstream entities. The method further includes computing the significance value of the one or more of the identified downstream and upstream data entities and identifying one or more dimensions of the identified downstream and upstream entities. The method furthermore includes determining a weighted aggregation of the identified one or more dimensions of the identified downstream and upstream entities and ranking the one or more dimensions of the entities based on the aggregate thus determined.

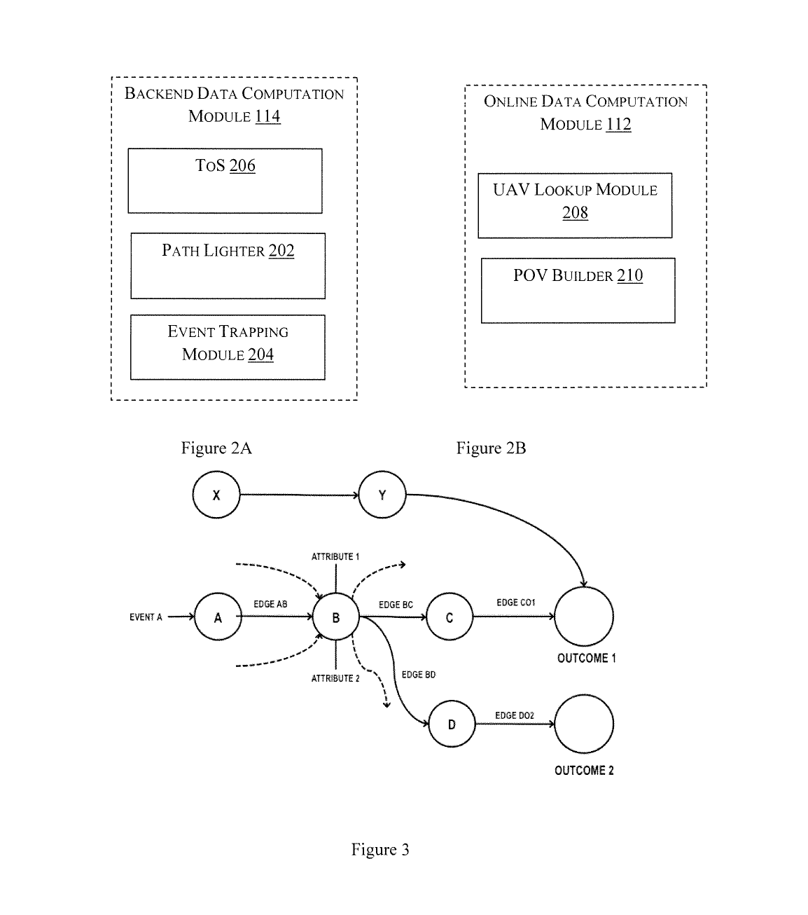

Further, the present disclosure relates to a system for enabling dynamic contextual ranking of multi-dimensional data. The system comprises a user application interface configured to receive information from one or more data source systems and a facet ranker coupled with the user application interface and configured to compute ranking of dimensions of the received information. The facet ranker comprises of at least a backend data computation module as illustrated in FIG. 2B configured to determine PoV vector offline based on the one or more attribute information of the data entity in consideration and any trigger events received on that data entity. The facet ranker further comprises an online data computation module coupled with the backend data computation module and configured to compute POV vector based on the navigation state of the user and a ranking module configured to rank the dimensions of the data entity based on the computed POV and UA vectors.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

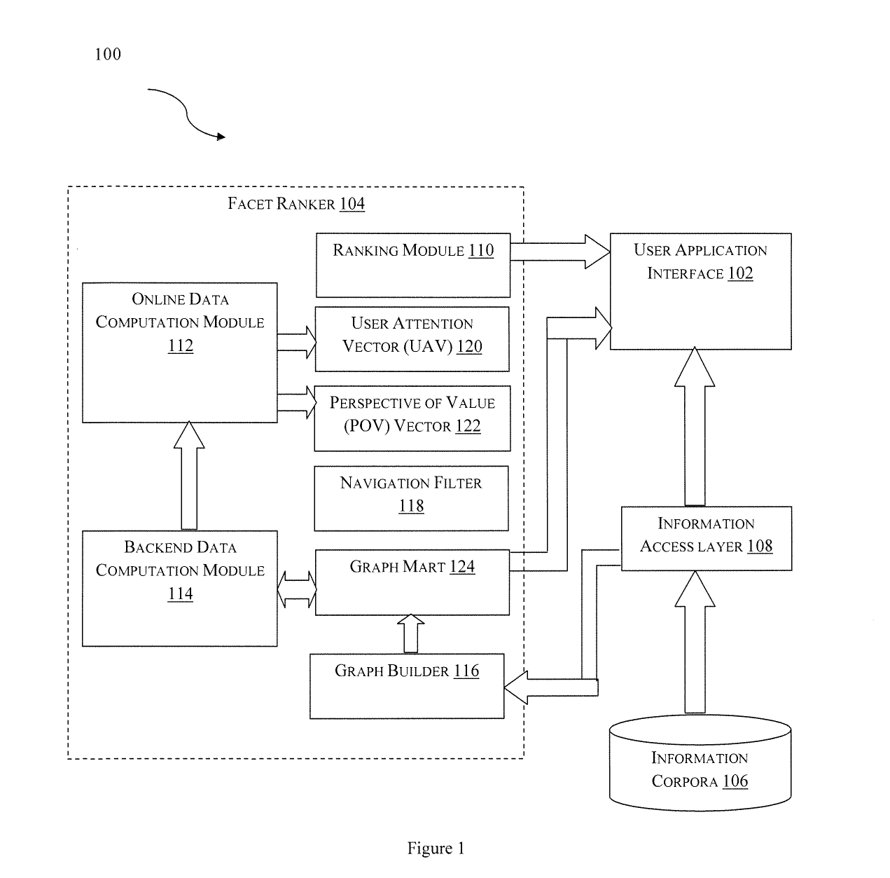

FIG. 1 illustrates an exemplary architecture of a contextual facet ranking system in accordance with an embodiment of the present disclosure.

The system (100) as shown in FIG. 1 comprises one or more core components and their high level interactions among the said components. In one embodiment, the system (100) comprises at least a user application interface (UI) (102), a facet ranker (104) coupled with the UI (102). The UI (102) is coupled with and configured to access the enterprise information corpora (106) via an information access layer (108).

The information corpora (106) is the ‘collection of information’ available within the enterprise. The information corpora (106) may include one or more databases distributed across various departments and across multiple locations. The information corpora (106) includes databases storing the industrial/enterprise information, and other information related to an organization that may be of interest to industry stakeholders. For example, the information corpora (106) may comprise knowledge repository databases, Item catalogs, Enterprise risk data, social influence data and so on. In one embodiment, the information corpora is classified into two different types based on the association between the information entities or data points. The types include Taxonomic relationship based repositories and Cause-Effect relationship based repositories. Taxonomic repositories comprise Item catalogs, knowledge repositories and Electronic Health Records (EHR). Cause-Effect repositories comprise Enterprise risk data, Social influence data and so on.

The information access layer (108) enables accessing or extraction of relevant data by the UI (102) from the information corpora (106). The UI (102) is further coupled with the facet ranker (104) and configured to provide relevant input data during the computation of rank of all information facets. The facet ranker (104) comprises one or more components and modules including at least a ranking module (110), an online data computation module (112), a backend data computation module (114), a graph builder (116), and navigation filter (118).

The ranking module (110) is configured to rank one or more information facets or dimensions based on the context of observation so as to enable the user to explore and attend to the information along its most relevant dimensions or perspectives. The context of observation is determined based on the context of the user and state of the information being observed. The context of observer defines how the user attention will be distributed across multiple facets of information based on the intent, goal and responsibility. The state of the observer is represented by a User Attention vector (UAV) (120). The UAV (120) is computed offline for multiple users based on the profile of the users and stored in a directory. The state of the information being observed is defined by value or level of significance of various facets of information. The state of the information being observed is represented by Perspective of value vector (POV) (122) that is computed independent of the users.

The backend data computation module (114) is configured to compute the level of significance of one or more entities and update the table of significance in offline mode based on data received from multiple data sources. Data sources include information corpora (106) that comprise at least Taxonomic and Cause-Effect repositories. The table of significance for Taxonomic repositories is also determined using any method or process available in the art. The table of significance for the Cause-Effect repositories is derived from a graph structure (Graph Mart) created by the Graph builder (116). The Graph builder (116) is configured to create a graph structure (Graph Mart) in accordance with Property graph model, and represent the enterprise data including data entities, attributes and dimensions of the entities, and associations/dependencies between the entities in the graph structure.

A property graph will consists of one or more elements including a set of Vertices, with each Vertex having a Unique Identifier, a Set of Outgoing Edges, a Set of Incoming Edges and Collection of Properties defined by a map from Key to Value. The set of Edges, with each Edge having a Unique identifier, Outgoing Tail Vertex, Incoming Head Vertex, Label that denotes the Type of Relationship between its two Vertices and Collection of Properties defined by a map from Key to Value. The graph builder configured to generate a graph structure comprising one or more vertices, and one or more outgoing and incoming edges associated between the vertices, wherein the vertices represent at least one of data entities, attributes and dimensions of the entities and the edges represent the type of association between the entities.

The Graph builder (116) is configured to create the graph mart (124) or graph summary to address the specific business problem or a specific business sub-domain by focusing on the Entities, Attributes, Dimensions and Associations that are related and relevant to that business problem. For an example, if a specific business problem is related to Supply Chain Risk Management, the Graph Mart (124) will essentially be created by the Graph builder (116) as a Risk Model that includes the Risk Attributes, Entities under Risk and Risk related associations. Similarly if the problem that is being addressed is ‘New Product Launch’, the Graph Summary will include Entities, Attributes and Associations linked to Product Launch.

Entities and their associations are directly map-able from the problem domain. E.g. In a supply chain scenario, a simple association of Supplier Facility ‘A’ supplies Component ‘B’, can be represented as a pair of Vertices and an Edge that captures the association between them. The names of the entities are identified as Property Key-Value pair with key as ‘Name’ and the Edge Label (in this case ‘SUPPLIES’) denotes the type of association between the entities. An additional set of Property ‘Key-Value’ pairs is used to capture a comprehensive set of Attributes & Dimensions.

In one embodiment, the Attributes include, but not limited to, the information regarding ‘State’ of the Entity and ‘Characteristics’/‘Features’ of the Entity relevant to the problem domain. Similarly Dimensions can include Structural Dimension and Information dimension. The Structural dimension is used to identify an Entity that can be as a part or a specialization of a High-level Entity. For example, Product Category—Product; Sourcing Location—Region. The Information dimension is used to group otherwise distinct Entities into some logical clusters like, for example, New Products that are to be launched this Season. In another embodiment, Attributes are more complex structures and they may be static in nature or temporal in nature. The Attributes are modeled based on the size of these data structure and the type of Vertex computation associated with them.

The Graph builder (116) is configured to construct graph structures and based on the stage of construction of the graph structure, the Graph builder (116) is configured to extract and load the data from various information sources into the graph mart (124). In one embodiment, the Graph builder (116) is configured to schedule synchronization of the graph mart (124) with one or more backend source systems. In another embodiment, the Graph builder (116) is configured to handle high priority data or critical events for feeding into the graph mart (124) in real time.

Upon constructing the graph structures, the backend data computation module (114) is configured to compute the level of significance of one or more entities and update the table of significance. As shown in FIG. 2A, the backend data computation module (114) comprises a path lighter module (202), an event trapping module (204) and also configured to enable the storage of table of significance (206). The path lighter module (202) is configured to perform one or more graph processing or graph traversal operations. The path lighter module (202) is configured to select a set of casual dimensions and perform graph traversal operations across the data entities for the selected set of dimensions. In one embodiment, the graph traversal operations include Forward graph traversal and Reverse graph traversal operations. The path lighter module (202) is configured to perform Forward graph traversal (alternatively known as Forward Significance Flow) and Reverse graph traversal (alternatively known as Reverse Significance Flow) on the constructed graph structure to determine the significance value of one or more data entity in offline mode. The path lighter module (202) is configured to determine the significance value of one or more entities and store the computed significance values in the table of significance (ToS) (206).

In one embodiment, the path lighter module (202) is configured to compute significance value of a particular data entity based on the one or more attribute information of the data entity in consideration. The significance value of the predetermined data entity is determined as a function of “State” that is a function of attributes of the data entity. Upon determination of the significance value, the path lighter module (202) identifies one or more downstream and upstream entities associated with the data entity in consideration.

In one embodiment, the path lighter module (202) identifies one or more downstream entities that are impacted by the specific “State” of the entity in consideration. The path lighter module (202) is configured to detect one or more outgoing edges from the data entity in consideration towards one or more downstream entities, based on the state and type of the outgoing edge and the significance value of the entity in consideration being above a predetermined threshold value. The path lighter module (202) is further configured to determine a weight associated with each of the identified outgoing edge towards the identified downstream entities and computes the significance value of the one or more of the identified downstream data entities. The unique identifier, the determined weight and dimension information of the identified downstream entities is then stored in a table of significance (TOS) (206).

The path lighter module (202) is configured to compute significance value of all the identified downstream entities until no more outgoing edges are identified or significance value of the downstream entity is lower than the predetermined threshold value or weight associated with at least one outgoing edge of the downstream entity is lower than a predetermined threshold weight. If there are multiple outgoing edges, flow associated with each of the outgoing edges is considered as separate end-to-end flows with unique path identification (ID). The path lighter module (202) is further configured to obtain back chaining information of the identified outgoing edges.

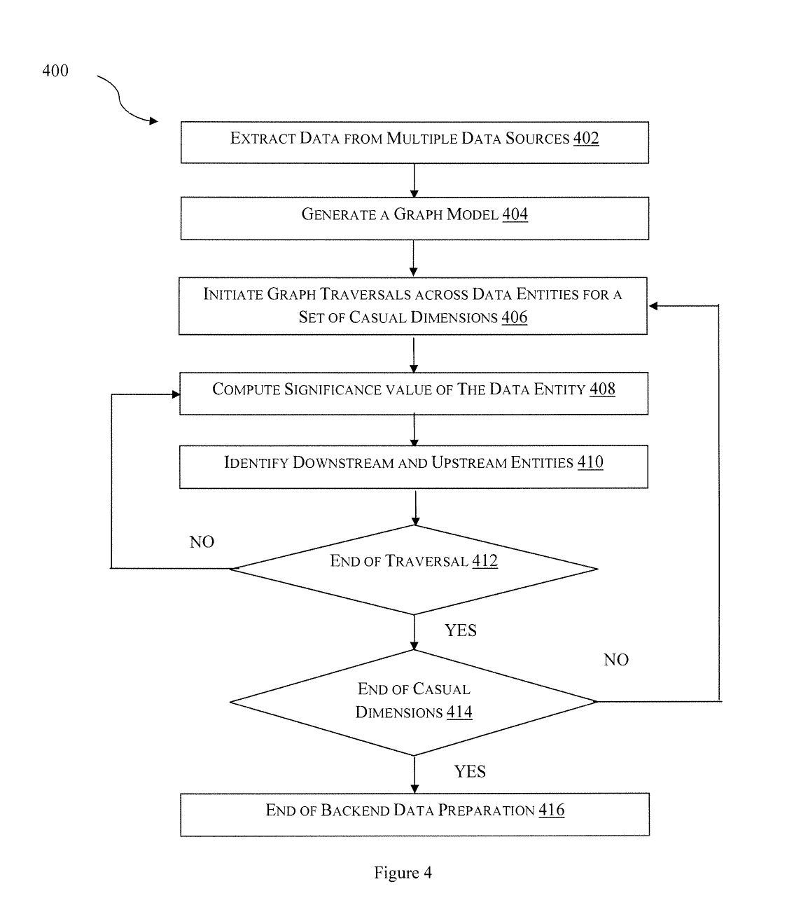

Further, the path lighter module (202) is configured to store the downstream entities along with the dimensional attributes in the Table of significance (206). If there are multiple paths involved during identification of downstream entities, then multiple entries for the same entity with different path ID will be stored in the Table of significance. For an example, as shown in FIG. 3, the state attribute of the node ‘B’ is computed based on the incoming edges (i.e., edge AB) and associated attributes. Further, the downstream entities represented by the outgoing edges BC and BD are selected and the graph traversals are performed involving multiple paths A-B-C.. and A-B-D. Further, the outgoing edges are back chained or tagged to the respective incoming edges like edge BC tagged to edge AB and edge BD is tagged to edge AB and the table of significance is updated.

The path lighter module (202) also identifies one or more upstream entities that cause a specific “Impact” to the data entity in consideration. The path lighter module (202) is configured to identify one or more incoming edges to the data entity in consideration from one or more downstream entities, based on the back chaining information and the significance value being above a predetermined threshold value. Further, the path lighter module (202) is configured to determine a weight associated with each incoming edge towards the identified upstream entities and store the unique identifier, the determined weight and dimension information of the identified upstream entities in the table of significance.

Further, the path lighter module (202) is configured to update the table of significance until no more incoming edges are identified or significance value of the upstream entity is lower than the predetermined threshold value or weight associated with at least one incoming edge of the upstream entity is lower than the predetermined threshold weight. The path lighter module (202) computes the significance value of the one or more identified downstream and upstream data entities and stores the same in the table of significance (206).

In an embodiment, if a triggering event on a particular data entity is received by the event trapping module (204), the path lighter module (202) computes the significance value of the data entity directly impacted by the triggering event. The significance value of the data entity is determined based on the one or more attribute information of the data entity in consideration. Further, the path lighter module (202) is configured to identify one or more downstream and upstream entities associated with the data entity in consideration and related to significance value and association of the data entity with the identified downstream and upstream entities. The path lighter module (202) is further configured to compute the significance value of the one or more of the identified downstream and upstream data entities and update the table of significance.

On computing the table of significance, the online data computation module (112) computes aggregated weight of dimensions of the identified downstream and upstream entities and derives the POV vector (122). The online data computation module (112) comprises at least a UAV lookup module (208) and a POV builder (210). The navigation filter module (118) is configured to receive navigation state of the user. The POV builder (210) is configured to receive the navigation state of the user from the navigation filter module (118) and derive the POV vector (122) based on the navigation state of the user thus received. The POV builder (210) is configured to determine the aggregate of weight associated with all dimensions and compute the POV vector (122) based on the navigation state of the user thus received.

The POV builder (210) is configured to receive navigation state of the user and derive the POV vector (122) based on the navigation state of the user thus received. The POV builder (210) is configured to determine the aggregate of weight associated with all dimensions and compute the POV vector (122) based on the navigation state of the user thus received.

The UAV lookup module (208) is configured lookup the user attention vector directory for mapping individual users to the corresponding UA vector (120). UAV are pre-computed for all users based on the intent, goal and responsibility or profile of the users obtained from the enterprise data. In one embodiment, the UA vector (120) for stakeholders working on enterprise systems may be derived from the responsibility matrix. In another embodiment, the UAV (120) for non-business or a typical user may be derived based on the general interest, hobbies, and objectives of the user, a priority matrix of the user across those dimensions is derived and converted into a UAV (120).

The ranking module (110) is configured to receive UAV and POV vectors from the online data computation module and rank all dimensions of data entities by overlaying the POV vector (122) with the UAV vector (120) thus received.

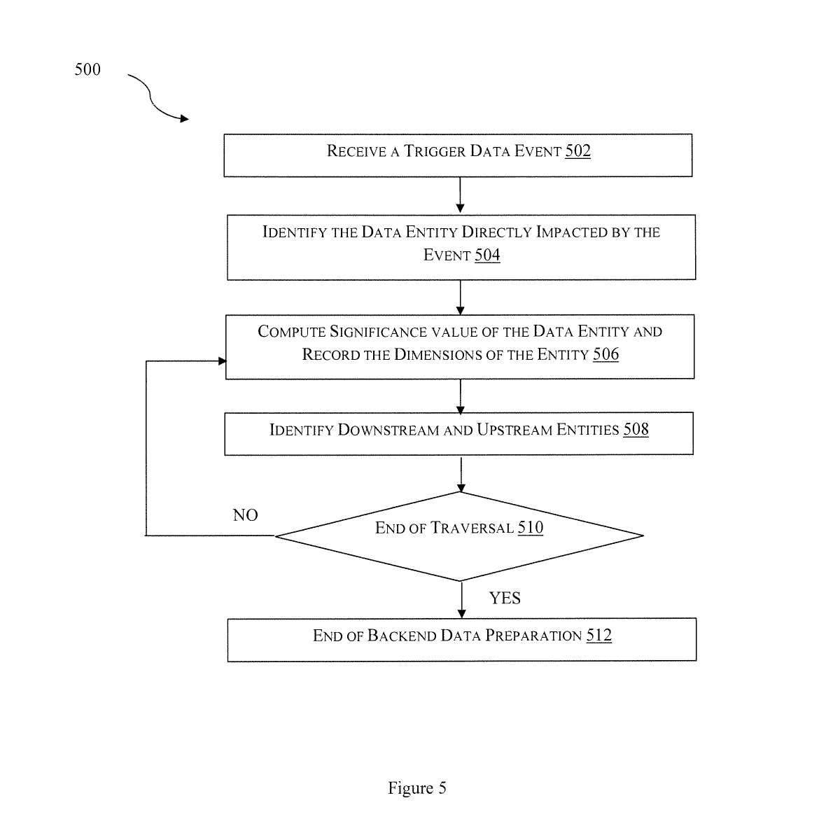

FIGS. 4 & 5 illustrate flowchart of method of Backend data computation in accordance with an embodiment of the present disclosure.

As shown in FIG. 4, the flowchart comprises one or more steps or blocks illustrating a method (400) performed by the Backend data computation module.

At step 402, data from multiple data sources are extracted. In one embodiment, data from multiple sources included in the information corpora (106) is extracted by the facet ranker module (104) via the information access layer (108). The information corpora (106) includes the databases storing the industrial/enterprise information and other information related to an organization that may be of interest to industrial stakeholders. For example, the information corpora (106) may comprise knowledge repository databases, Item catalogs, Enterprise risk data, social influence data and so on.

At step 404, a graph model is generated. In one embodiment, the Graph builder (116) is configured to create the graph mart (124) or graph summary to address the specific business problem or a specific business sub-domain by focusing on the Entities, Attributes, Dimensions and Associations that are related and relevant to that business problem.

At step 406, a set of casual dimensions is selected and graph traversal is initiated across data entities for the selected set of dimensions. Upon constructing the graph structures, the backend data computation module (114) is configured to compute the table of significance. In one embodiment, the path lighter module (202) is configured to select a set of casual dimensions and perform graph traversal operations across the data entities for the selected set of dimensions. The graph traversal operations include Forward graph traversal and Reverse graph traversal operations. The path lighter module (202) is configured to perform Forward graph traversal (alternatively known as Forward Significance Flow) and Reverse graph traversal (alternatively known as Reverse Significance Flow) on the constructed graph structure to determine the significance value of one or more data entities in offline mode.

At step 408, significance value of the data entity is computed. In one embodiment, the path lighter module (202) is configured to compute significance value of a particular data entity based on the one or more attribute information of the data entity in consideration. The significance value of the data entity is determined as a function of “State” that is a function of attributes of the data entity.

At step 410, downstream and upstream entities are identified. In one embodiment, the path lighter module (202) identifies one or more downstream entities that are impacted by the specific “State” of the entity in consideration. The path lighter module (202) is configured to detect one or more outgoing edges from the data entity in consideration towards one or more downstream entities, based on the state and type of the outgoing edge and the significance value of the entity in consideration being above a predetermined threshold value. The path lighter module (202) is further configured to determine a weight associated with each of the identified outgoing edge towards the identified downstream entities and computes the significance value of the one or more of the identified downstream data entities. The identifier, the determined weight and dimension information of the identified downstream entities is then stored in a table of significance (TOS) (206).

The path lighter module (202) is configured to identify one or more incoming edges to the data entity in consideration from one or more downstream entities, based on the back chaining information and the significance value being above a predetermined threshold value. Further, the path lighter module (202) is configured to determine a weight associated with each incoming edge towards the identified upstream entities and store the identifier, the determined weight and dimension information of the identified upstream entities in the table of significance.

At step 412, it is determined whether the end of the traversal operations is reached. In one embodiment, the path lighter module (202) is configured to compute significance value of all the identified downstream entities until no more outgoing edges are identified or significance value of the downstream entity is lower than the predetermined threshold value or weight associated with at least one outgoing edge of the downstream entity is lower than a predetermined threshold weight. If it is determined that at least one of the above condition is satisfied, then the method flows to step (414) along the “YES” path, otherwise flows to step (408) along the “NO” path.

At step 414, it is determined whether the graph traversal for all the selected dimensions is completed. If it is determined that there are no more graph traversal operations for a selected dimension to proceed, the method determined whether the graph traversal operations for all selected dimensions is complete. If it is completed, then the method flows to step (416) along the “YES” path, otherwise flows to step (406) along the “NO” path.

At step 416, backend data preparation method ends.

The method (500), as shown in FIG. 5, illustrates a flowchart of the backend data computation module (114) to compute the table of significance when a triggering data event is received on a data entity.

At step 502, a triggering data event is received on a data entity. In an embodiment, the event trapping module (204) receives a triggering event on a particular data entity.

At step 504, data entities directly impacted by the triggering event are identified. In one embodiment, the path lighter module (202) identifies one or more data entities that are directly impacted by the triggering event.

At step 506, significance value of the data entity is identified and dimensions of the entity are recorded. In one embodiment, the path lighter module (202) is configured to determine significance value of the data entity in consideration and update the table of significance. The significance value of the data entity is determined based on the one or more attribute information of the data entity in consideration.

At step 508, downstream and upstream entities are identified. In one embodiment, the path lighter module (202) is configured to identify one or more downstream and upstream entities associated with the data entity in consideration and related to significance value and association of the data entity with the identified downstream and upstream entities. The path lighter module (202) is further configured to compute the significance value of the one or more of the identified downstream and upstream data entities and update the table of significance.

At step 510, it is determined whether the end of the traversal operations is reached. In one embodiment, the path lighter module (202) is configured to compute significance value of all the identified downstream entities until no more outgoing edges are identified or significance value of the downstream entity is lower than the predetermined threshold value or weight associated with at least one outgoing edge of the downstream entity is lower than a predetermined threshold weight. If it is determined that at least one of the above condition is satisfied, then the method flows to step (512) along the “YES” path, otherwise flows to step (506) along the “NO” path.

At step 512, backend data preparation method ends.

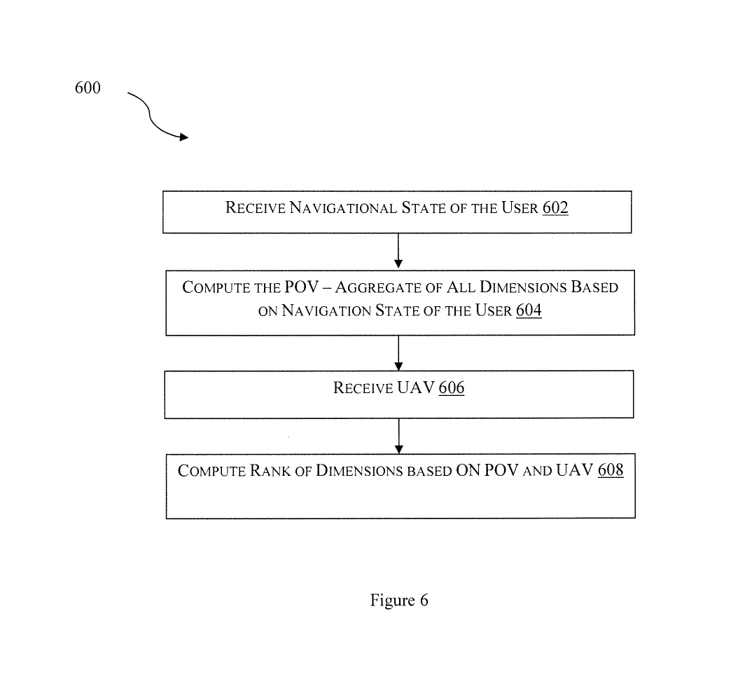

FIG. 6 illustrates a flowchart of method of contextual ranking of information facets in accordance with an embodiment of the present disclosure.

The method (600), as shown in FIG. 6, illustrates a flowchart of online data computation module (112) to compute the ranking of information dimensions online.

At step 602, navigational state of the user is received. In one embodiment, the navigation filter (118) is configured to receive the navigational state or path taken by the user from the user interface (102).

At step 604, POV vector is computed. In one embodiment, the POV builder (210) is configured to receive navigation state of the user and derive the POV vector (122) based on the navigation state of the user thus received. The POV builder (210) is configured to determine the aggregate of weight associated with all dimensions and compute the POV vector (122) based on the navigation state of the user thus received.

At step 606, UAV vector is received. In one embodiment, the UAV lookup module (208) is configured to lookup the user attention vector directory for mapping individual users to the corresponding UA vector (120). UAV are pre-computed for all users based on the intent, goal and responsibility or profile of the users obtained from the enterprise data. In one embodiment, the UA vector (120) for industrial stakeholders working on enterprise systems may be derived from the responsibility matrix. In another embodiment, the UAV (120) for non-business or a typical user may be derived based on the general interest, hobbies, and objectives of the user, a priority matrix of the user across those dimensions is derived and converted into a UAV (120).

At step 608, rank of dimensions based on POV and UAV vectors is computed. In one embodiment, the ranking module (110) is configured to receive UAV and POV vectors from the online data computation module and rank all dimensions of data entities by overlaying the POV vector (122) with the UAV vector (120) thus received.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method of dynamic and contextual ranking of information facets of multi-dimensional data, the method comprising:
receiving by a facet ranking computing device information from one or more data source systems;
generating by the facet ranking computing device a data model for the received information corpora, the data model comprising one or more of at least data entities, attributes and dimensions of the data entities, or associations between the data entities derived from the received information corpora;
determining by the facet ranking computing device a significance value of the data entity based on the one or more attribute information of the data entity in consideration and any triggering events received on that data entity
identifying by the facet ranking computing device one or more downstream and upstream entities associated to the data entity in consideration and related to significance value and association of the data entity with the identified downstream and upstream entities;
computing by the facet ranking computing device the significance value of the one or more of the identified downstream and upstream data entities;
identifying by the facet ranking computing device one or more dimensions of the identified downstream and upstream entities;
determining by the facet ranking computing device an weighted aggregation of the identified one or more dimensions of the identified downstream and upstream entities; and
ranking by the facet ranking computing device the one or more dimensions of the entities based on the aggregate thus determined.

2. The method as claimed in claim 1, wherein generating the data model comprising:
generating by the facet ranking computing device a graph structure consisting of one or more vertices, and one or more outgoing and incoming edges associated between the vertices, wherein the vertices represent at least one of data entities, attributes and dimensions of the entities and the edges represent the type of association between the entities.

3. The method as claimed in claim 1, wherein identifying one or more downstream and upstream entities comprising:
identifying by the facet ranking computing device one or more outgoing edges from the data entity in consideration towards one or more downstream entities, based on the state and type of the outgoing edge and the significance value of the entity in consideration being above a predetermined threshold value;
determining by the facet ranking computing device a weight associated with each of the identified outgoing edge towards the identified downstream entities;
computing by the facet ranking computing device the significance value of the one or more of the identified downstream data entities;
storing by the facet ranking computing device the identifier, the determined weight and dimension information of the identified downstream entities in a table of significance (TOS);
obtaining by the facet ranking computing device back chaining information of the identified outgoing edges to the incoming edge or the causal event that triggered the forward flow;
repeating by the facet ranking computing device the above steps until no more outgoing edges are identified, or a significance value of the downstream entity is lower than the predetermined threshold value, or a weight associated with at least one outgoing edge of the downstream entity is lower than a predetermined threshold weight, wherein the downstream entities are identified with the impacted state attribute information.

4. The method as claimed in claim 1, wherein identifying one or more upstream entities comprising:
identifying by the facet ranking computing device one or more incoming edges to the data entity in consideration from one or more downstream entities, based on the back chaining information and the significance value of the entity in consideration being above a predetermined threshold value;
determining by the facet ranking computing device a weight associated with each incoming edge towards the identified upstream entities;
storing by the facet ranking computing device the identifier, the determined weight and dimension information of the identified upstream entities in the table of significance (TOS);
repeating by the facet ranking computing device the above steps until no more incoming edges are identified, or significance value of the upstream entity is lower than the predetermined threshold value, or weight associated with at least one incoming edge of the upstream entity is lower than the predetermined threshold weight, wherein the upstream entities are identified with the “impacting” state attribute information.

5. The method as claimed in claim 1, wherein determining an aggregate comprising:
determining by the facet ranking computing device the aggregate of weight associated with all dimensions; and
computing by the facet ranking computing device a perspective of value (POV) vector.

6. The method as claimed in claim 1, wherein ranking comprising:
ranking by the facet ranking computing device the dimensions based on the computed PoV vector and predetermined User attention vector (UA), wherein the UA vector comprises value representing a user's attention on multiple dimensions of the information corpora; and
filtering by the facet ranking computing device the ranked dimensions based on the navigation state of the user and dynamically ranking the dimensions in accordance with the user's state of navigation.

7. A facet ranking computing device comprising:
a processor;
a memory, wherein the memory coupled to the processor which are configured to execute programmed instructions stored in the memory comprising
receiving information from one or more data source systems;
generating a data model for the received information corpora, the data model comprising one or more of at least data entities, attributes and dimensions of the data entities, or associations between the data entities derived from the received information corpora;
determining a significance value of the data entity based on the one or more attribute information of the data entity in consideration and any triggering events received on that data entity
identifying one or more downstream and upstream entities associated to the data entity in consideration and related to significance value and association of the data entity with the identified downstream and upstream entities;
computing the significance value of the one or more of the identified downstream and upstream data entities;
identifying one or more dimensions of the identified downstream and upstream entities;
determining an weighted aggregation of the identified one or more dimensions of the identified downstream and upstream entities; and
ranking the one or more dimensions of the entities based on the aggregate thus determined.

8. The device of claim 7 wherein the processor is further configured to execute programmed instructions stored in the memory for generating the data model further comprises generating a graph structure consisting of one or more vertices, and one or more outgoing and incoming edges associated between the vertices, wherein the vertices represent at least one of data entities, attributes and dimensions of the entities and the edges represent the type of association between the entities.

9. The device of claim 7 wherein the processor is further configured to execute programmed instructions stored in the memory for identifying one or more downstream and upstream entities further comprises:
identifying one or more outgoing edges from the data entity in consideration towards one or more downstream entities, based on the state and type of the outgoing edge and the significance value of the entity in consideration being above a predetermined threshold value;
determining a weight associated with each of the identified outgoing edge towards the identified downstream entities;
computing the significance value of the one or more of the identified downstream data entities;
storing the identifier, the determined weight and dimension information of the identified downstream entities in a table of significance (TOS);
obtaining back chaining information of the identified outgoing edges to the incoming edge or the causal event that triggered the forward flow;
repeating the above steps until no more outgoing edges are identified, or a significance value of the downstream entity is lower than the predetermined threshold value, or a weight associated with at least one outgoing edge of the downstream entity is lower than a predetermined threshold weight, wherein the downstream entities are identified with the impacted state attribute information.

10. The device of claim 7 wherein the processor is further configured to execute programmed instructions stored in the memory for identifying one or more upstream entities further comprising:
identifying one or more incoming edges to the data entity in consideration from one or more downstream entities, based on the back chaining information and the significance value of the entity in consideration being above a predetermined threshold value;
determining a weight associated with each incoming edge towards the identified upstream entities;
storing the identifier, the determined weight and dimension information of the identified upstream entities in the table of significance (TOS);
repeating the above steps until no more incoming edges are identified, or significance value of the upstream entity is lower than the predetermined threshold value, or weight associated with at least one incoming edge of the upstream entity is lower than the predetermined threshold weight, wherein the upstream entities are identified with the “impacting” state attribute information.

11. The device of claim 7 wherein the processor is further configured to execute programmed instructions stored in the memory for determining an aggregate further comprises:
determining the aggregate of weight associated with all dimensions; and
computing a perspective of value (POV) vector.

12. The device of claim 7 wherein the processor is further configured to execute programmed instructions stored in the memory for the ranking further comprises:
ranking the dimensions based on the computed PoV vector and predetermined User attention vector (UA), wherein the UA vector comprises value representing a user's attention on multiple dimensions of the information corpora; and
filtering the ranked dimensions based on the navigation state of the user and dynamically ranking the dimensions in accordance with the user's state of navigation.

13. A non-transitory computer readable medium having stored thereon instructions for dynamic and contextual ranking of information facets of multi-dimensional data comprising machine executable code which when executed by at least one processor, causes the processor to perform steps comprising:
receiving information from one or more data source systems;
generating a data model for the received information corpora, the data model comprising one or more of at least data entities, attributes and dimensions of the data entities, or associations between the data entities derived from the received information corpora;
determining a significance value of the data entity based on the one or more attribute information of the data entity in consideration and any triggering events received on that data entity
identifying one or more downstream and upstream entities associated to the data entity in consideration and related to significance value and association of the data entity with the identified downstream and upstream entities;
computing the significance value of the one or more of the identified downstream and upstream data entities;
identifying one or more dimensions of the identified downstream and upstream entities;
determining an weighted aggregation of the identified one or more dimensions of the identified downstream and upstream entities; and
ranking the one or more dimensions of the entities based on the aggregate thus determined.

14. The medium of claim 13 wherein the generating the data model further comprises generating a graph structure consisting of one or more vertices, and one or more outgoing and incoming edges associated between the vertices, wherein the vertices represent at least one of data entities, attributes and dimensions of the entities and the edges represent the type of association between the entities.

15. The medium of claim 13 wherein the identifying one or more downstream and upstream entities further comprises:
identifying one or more outgoing edges from the data entity in consideration towards one or more downstream entities, based on the state and type of the outgoing edge and the significance value of the entity in consideration being above a predetermined threshold value;
determining a weight associated with each of the identified outgoing edge towards the identified downstream entities;
computing the significance value of the one or more of the identified downstream data entities;
storing the identifier, the determined weight and dimension information of the identified downstream entities in a table of significance (TOS);
obtaining back chaining information of the identified outgoing edges to the incoming edge or the causal event that triggered the forward flow;
repeating the above steps until no more outgoing edges are identified, or a significance value of the downstream entity is lower than the predetermined threshold value, or a weight associated with at least one outgoing edge of the downstream entity is lower than a predetermined threshold weight, wherein the downstream entities are identified with the impacted state attribute information.

16. The medium of claim 13 wherein identifying one or more upstream entities further comprising:
identifying one or more incoming edges to the data entity in consideration from one or more downstream entities, based on the back chaining information and the significance value of the entity in consideration being above a predetermined threshold value;
determining a weight associated with each incoming edge towards the identified upstream entities;
storing the identifier, the determined weight and dimension information of the identified upstream entities in the table of significance (TOS);
repeating the above steps until no more incoming edges are identified, or significance value of the upstream entity is lower than the predetermined threshold value, or weight associated with at least one incoming edge of the upstream entity is lower than the predetermined threshold weight, wherein the upstream entities are identified with the “impacting” state attribute information.

17. The medium of claim 13 wherein the determining an aggregate further comprises:
determining the aggregate of weight associated with all dimensions; and
computing a perspective of value (POV) vector.

18. The medium of claim 13 wherein the ranking further comprises:
ranking the dimensions based on the computed PoV vector and predetermined User attention vector (UA), wherein the UA vector comprises value representing a user's attention on multiple dimensions of the information corpora; and
filtering the ranked dimensions based on the navigation state of the user and dynamically ranking the dimensions in accordance with the user's state of navigation.
